(19) United States
(12) Patent Application Publication
(10) Pub. No.: US 2010/0146511 A1
(43) Pub. Date: Jun. 10, 2010

(54) POLICY BASED DATA PROCESSING METHOD AND SYSTEM

(75) Inventors: Hee Sook MO, Daejeon (KR); Hyochan BANG, Daejeon (KR); Jee Sook EUN, Daejeon (KR); Se Won OH, Daejeon (KR); Jae Gak HWANG, Daejeon (KR); Cheol Sig PYO, Daejeon (KR); Jong-Suk CHAE, Daejeon (KR); Jae Guen KIM, Gyeonggi-do (KR); Gi Su KIM, Seongnam-si (KR); Jai Yeol KIM, Seongnam-si (KR)

Correspondence Address: Jae Y. Park, Kile, Goekjian, Reed & McManus, PLLC, 1200 New Hampshire Ave. NW, Suite 570, Washington, DC, 20036, US

(73) Assignees: ELECTRONICS AND TELECOMMUNICATIONS RESEARCH INSTITUTE, Daejeon (KR); WAREPLUS CO., LTD., Seongnam-si (KR)

(21) Appl. No.: 12/542,233

(22) Filed: Aug. 17, 2009

(30) Foreign Application Priority Data
Dec. 9, 2008 (KR) 10-2008-0124871

(51) Int. Cl. G06F 9/46

(52) U.S. Cl. 718/103; 719/318

(57) ABSTRACT

Provided is a policy-based data processing system and method. A pattern analyzer of the data processing system generates a pattern handler based on a pattern, schedules the generated pattern handler based on a policy to filter and group data, generates a processing function corresponding to a process type for each data type of event data into an object module, and uses it by handling it through a pattern handler.

### CROSS-REFERENCE TO RELATED APPLICATION

This application claims priority to and the benefit of Korean Patent Application No. 10-2008-0124871 filed in the Korean Intellectual Property Office on Dec. 9, 2008, the entire contents of which are incorporated herein by reference.

### BACKGROUND OF THE INVENTION

(a) Field of the Invention

The present invention relates to a policy-based data processing system and method. Particularly, the present invention relates to a data processing system and method for filtering and grouping data that are collected through the radio frequency identification/ubiquitous sensor network infrastructure.

(b) Description of the Related Art

The radio frequency identification (RFID)/ubiquitous sensor network (USN) skill may allow a plurality of radio sensing devices to sense data simultaneously because of the skill's characteristics. Accordingly, inaccurate repeated data are generated, and the RFID/USN middleware system uses a software filter for filtering the inaccurate repeated data.

The filter filters the data by applying a simplified pattern to REID tag data and sensing data, and collecting or discarding the data according to the matching states, and hence, it is used to eliminate unneeded data instead of extracting the data required for an application service. Therefore, when the filter is used, it is difficult to provide a filtering function for analyzing the data that are collected from the RFID/USN infrastructure and filtering the data needed for the application service.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a data processing system and method for providing data required by various application services by efficiently filtering or grouping the data.

An exemplary embodiment of the present invention provides a data processing system for processing event data collected from a radio frequency identification/ubiquitous network, including: a pattern handler for handling a processing function for applying a corresponding pattern to a field of the event data; a pattern handler generator for generating the pattern handler corresponding to a pattern when receiving the pattern; and a scheduler for determining an application order of the input pattern based on the policy, and controlling drive and stop of the pattern handler according to the determined application order.

Another embodiment of the present invention provides a data processing system for processing event data collected from a radio frequency identification/ubiquitous network, including: a data type processing module including a processing function that is generated to be an object module for each data type; a pattern analyzer for determining an application order of a pattern based on a policy, and handling a corresponding processing function from the data type processing module according to the pattern's application order; and a data filter for filtering the event data in linkage with the pattern analyzer.

Yet another embodiment of the present invention provides a method for processing event data collected from a radio frequency identification/ubiquitous network, including: a pattern handler for handling a processing function of a corresponding pattern; determining a drive order of the pattern handier based on a policy; and filtering or grouping the event data by using the pattern handler activated according to the drive order.

### BRIEF DESCRIPTION OF THE DRAWINGS

FIG. 1 shows a configuration diagram of a data processing system according to an exemplary embodiment of the present invention.

FIG. 2 shows a detailed view of a pattern analyzer according to an exemplary embodiment of the present invention.

FIG. 3 shows a flowchart of a data processing method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A policy-based data processing system and method for processing data that are collected through an RFID/USB infrastructure according to an exemplary embodiment of the present invention will now be described in detail with reference to drawings.

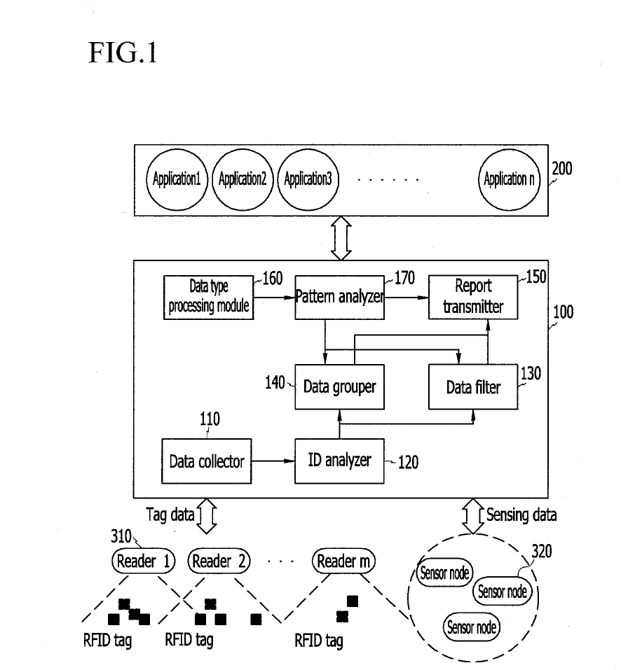

FIG. 1 shows a configuration diagram of a data processing system according to an exemplary embodiment of the present invention.

Referring to FIG. 1, the data processing system includes a middleware system 100 and an application system 200.

The middleware system 100 includes a data collector 110, an identifier analyzer 120, a data filter 130, a data grouper 140, a report transmitter 150, a data type processing module 160, and a pattern analyzer 170.

The data collector 110 collects event data through the RFID/USN infrastructure, and stores the collected event data in a storage unit (not shown) in realtime so that no data loss may occur. That is, data collector 110 collects tag data having recognized the RFID tag or collects sensing data having sensed the environments through RFID readers (reader 1, reader 2, . . . , reader m) 310 and a sensor node 320 that are the RFID/USN infrastructure.

The RF recognizing devices such as the RFID reader 310 or the sensor node 320 may repeatedly recognize the same event data, or they may interfere with each other when collecting the event data because of repetition and interference of the recognition area. Accordingly, repeatedly recognized event data or noise data are generated, and they are transmitted to the middleware system 100.

The identifier analyzer 120 analyzes an identifier of the event data collected by the data collector 110 to converts it into an ID code.

The data filter 130 filters the ID code converted by the identifier analyzer 120 according to a filter pattern in linkage with the pattern analyzer 170.

The data grouper 140 groups the event data that are collected in linkage with the pattern analyzer 170 or the event data that are filtered by the data filter 130 according to a group pattern based on the ID code converted by the identifier analyzer 120.

The report transmitter 150 generates an event report to be transmitted for the respective applications (application1, application2, . . . , application n) based on the event data that are filtered by the data filter 130 or the data that are grouped by the data grouper 140, and transmits the generated event report to the application system 200.

The data type processing module 160 manages a processing function that is an object module for each data type of the event data. The data type of the event data that are collected through the RFID/USN infrastructure corresponds to the process type of the event data, and it includes an electronic product code type for processing the electronic product code, a unit type for processing arithmetic data, and a string type for processing a character group.

Accordingly, since an additional processing function is generated to be an object module for each data type in the exemplary embodiment of the present invention, it is easy to add a new data type or change the processing function according to the data type.

The pattern analyzer 170 analyzes the input policy, and schedules a filter pattern based on the policy. That is, the pattern analyzer 170 determines the filter pattern's activation time, application order, and activation condition based on the activation policy, priority policy, and condition processing policy, and then determines the application order for the filter pattern. The pattern analyzer 170 calls the corresponding processing function from the data type processing module 160 according to the determined application order for the filter pattern. The called processing function is combined based on the filter pattern and it is then used for filtering by the data filter 130.

Also, the pattern analyzer 170 schedules the group pattern based on the policy. That is, the pattern analyzer 170 analyzes the policy to determine the group pattern's activation time, application order, and activation condition, and then determines the application order of the group pattern. The pattern analyzer 170 calls the corresponding processing function from the data type processing module 160 according to the determined application order of the group pattern, and combines the called processing function based on the group pattern to be used for grouping by the data grouper 140.

Also, the pattern analyzer 170 applies the filter pattern or the group pattern based on the policy, and outputs matching states of the applied pattern.

The application system 200 performs a corresponding application based on the event report provided by the middleware system 100.

As described above, the same filter pattern and group pattern are designed to be differently applied depending on the policy, thereby allowing easy application of a new policy or a change of a policy.

The data processing system has been exemplified to include the data filter 130 and the data grouper 140 in the exemplary embodiment of the present invention, and it can also include one of the two constituent elements in the present invention.

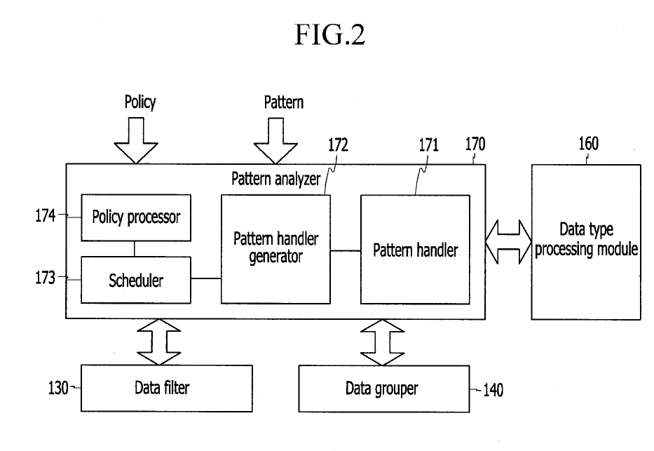

FIG. 2 shows a detailed view of a pattern analyzer 170 according to an exemplary embodiment of the present invention.

Referring to FIG. 2, the pattern analyzer 170 includes a pattern handler 171, a pattern handler generator 172, a scheduler 173, and a policy processor 174.

The pattern handler 171 handles the processing function for applying the corresponding pattern (filter pattern or group pattern) to respective fields of the event data. That is, the pattern handler 171 calls the processing function for filtering or grouping the event data according to the corresponding pattern from the data type processing module 160 and performs the processing function.

The pattern handler generator 172 generates the pattern handier 171 for processing the event data for each filter pattern or group pattern.

The scheduler 173 schedules one of the filter pattern and the group pattern based on the policy analysis results (activation policy, priority policy, and condition processing policy) by the policy processor 174, and drives or stops the corresponding pattern handler 171 according to the application order of the filter pattern or the group pattern.

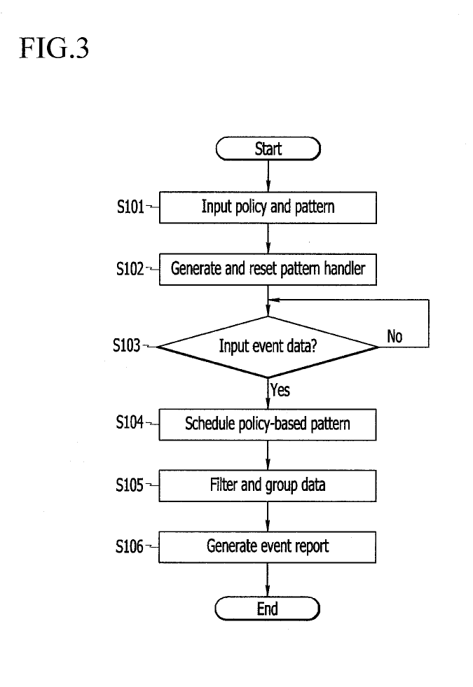

FIG. 3 shows a flowchart of a data processing method by an RFID/USN data processing system according to an exemplary embodiment of the present invention.

Referring to FIG. 3, upon receiving the policy and pattern (filter pattern or group pattern) in the specification standard format (S101), the data processing system analyzes it through the pattern analyzer 170 to generate a pattern handler 171 corresponding to each pattern, and resets the same (S102).

Upon receiving the event data from one of the RFID reader 310 and the sensor node 320 (S103), the data processing system drives the generated pattern handler 171, the data filter 130, and the data grouper 140. That is, the pattern analyzer 170 of the data processing system schedules the filter pattern or the group pattern based on the policy ($104), and drives the pattern handler 171 according to the pattern application order to filter and group the data (S105). For example, when scheduling the filter pattern or the group pattern based on the priority policy, the pattern analyzer 170 determines the application order of the pattern based on the pattern's priority. The pattern analyzer 170 filters and groups the data while sequentially driving and stopping the pattern handler 171 according to the application order.

When the data are filtered and grouped according to the scheduled pattern application order, the data processing system generates an event report for the filtered or grouped event data through the report transmitter 150 (S106), and transmits it to the application system 200.

A method for processing data by applying the policy-based pattern described with reference to Table 1 will now be described. Table 1 shows an example for differently applying the goods selecting reference value (filter pattern) and the grade selecting reference value (group pattern) according to agricultural product harvest time.

TABLE 1
An example of pattern application depending on agricultural
product harvest time

| Items | Jan. to Jul. | Aug. to Sep. | Oct. to Dec. |
|---|---|---|---|
| Product range | 1~100 KG | 1.5~100 KG | 1~100 KG |
| (Filter) | | | |
| Grade range | 1: Over 2.5 KG | 1: Over 3.1 KG | 1: Over 2.5 KG |
| (Group) | 2: 2.4~21. KG | 2: 2.5~3.0 KG | 2: 2.4~2.1 KG |
| | 3: 2.0~1.5 KG | 3: 2.4~2.1 KG | 3: 2.0~1.5 KG |
| | 4: 1.4~1.0 KG | 4: 2.0~1.5 KG | 4: 1.4~1.0 KG |

In the case of processing data by using Table 1, the data processing system applies the goods selecting reference value to the collected goods data (tag data or sensing information) with the filter pattern to filter the same, and the grade selecting reference value to the filtered goods data with the group pattern to classify the respective goods according to their grades.

In the case of processing the data by using Table 1, conventionally, the existing specification standards (filter pattern and group pattern) are discarded and a new specification standard is applied to filter and group the data. That is, when August comes, the specification standard used from January to July is discarded and a new specification standard is applied to filter and group the data.

However, the data processing system according to the exemplary embodiment of the present invention can apply different patterns for respective harvests and can process data by adding the pattern's priority and activation time to the specification standard (filter pattern, group pattern) in order to sequentially activate different patterns according to the pattern's activation policy or priority policy to be used for filtering and grouping, without discarding the existing specification standard and generating a new specification standard.

Further, when the ALE standard of the EPCglobal which is the standard in the RFID industry field is used as the specification standard, it is possible to generate a specification standard extended from the pattern standard defined by the ALE 1.1 standard of the EPCglobal in the exemplary embodiment of the present invention.

Pattern format: urn:ssi:pat:<Type>:<Priority>:<Period>:<General Pattern String>

ex) urn:ssi:pat:uint:0:**** 8-9*:[1.5-100]

According to an embodiment of the present invention, by applying a policy-based pattern other than simple pattern matching and filtering and grouping the data, it is possible to filter and group the data to which an application service's request is applied and efficiently eliminate an undesired process of discarding an existing filter and developing a new filter according to a change of an application service.

Further, when a data process type is changed or is newly added, it is generated to be an object module applicable to the system, thereby allowing easy system expansion or change.

Also, it is possible to input a filter pattern and a group pattern by using an extended specification that is compatible with the existing specification standard, thereby allowing the manager to be more easily adapted to the changed system.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments it is to be understood that the invention is not limited to the disclosed embodiments, but, on the contrary, is intended to cover various modifications and equivalent arrangements included within the spirit and scope of the appended claims.

What is claimed is:

1. A data processing system for processing event data collected from a radio frequency identification/ubiquitous network, the system comprising:
a pattern handler for handling a processing function for applying a corresponding pattern to a field of event data;
a pattern handler generator for generating the pattern handler corresponding to a pattern when receiving the pattern; and
a scheduler for determining an application order of the input pattern based on the policy, and controlling drive and stop of the pattern handler according to the determined application order.

2. The data processing system of claim 1, further including
a data type processing module for generating the processing function into an object module and managing the same.

3. The data processing system of claim 1, wherein
the pattern handler handles a processing function for filtering the event data based on the corresponding filter pattern.

4. The data processing system of claim 1, wherein
the pattern handler handles a processing function for grouping the event data based on the corresponding group pattern.

5. A data processing system for processing event data collected from a radio frequency identification/Ubiquitous network, the system comprising:
a data type processing module including a processing function that is generated to be an object module for each data type;
a pattern analyzer for determining an application order of a pattern based on a policy, and handling a corresponding processing function from the data type processing module according to the pattern's application order; and
a data filter for filtering the event data in linkage with the pattern analyzer.

6. The data processing system of claim 5, further including
a data grouper for grouping the event data in linkage with the pattern analyzer.

7. The data processing system of claim 5, wherein
the pattern analyzer generates a pattern handler for handling a processing function of a corresponding pattern from among processing functions included in the data type module, and controls drive and stop of the pattern handler according to the pattern's application order.

8. A method for processing event data collected from a radio frequency identification/ubiquitous network, the system comprising:
a pattern handler for handling a processing function of a corresponding pattern;
determining a drive order of the pattern handler based on a policy; and
filtering or grouping the event data by using the pattern handler activated according to the drive order.

9. The method of claim 8, further including
receiving the pattern and the policy in the specification standard form.

10. The method of claim 8, further including
generating the processing function to be an object module for each data type.

11. The method of claim 9, wherein
the filtering or grouping includes filtering or grouping the event data by calling one of the processing functions that are generated into object modules for each data type through the activated pattern handler.

12. The method of claim 8, wherein
the determining includes determining an drive order of the pattern handler based on the policy including the pattern's priority or activation time.
